(19) United States
(12) Patent Application Publication
(10) Pub. No.: US 2019/0072197 A1
(43) Pub. Date: Mar. 7, 2019

(54) CARBON-FIBER SEAT FOR A PNEUMATIC HAMMER

(71) Applicant: Jian-Shiou LIAW, Taichung (TW)

(72) Inventor: Jian-Shiou LIAW, Taichung (TW)

(21) Appl. No.: 15/694,455

(22) Filed: Sep. 1, 2017

(51) Int. Cl. F16K 25/00; F16K 17/20; B25D 9/16

(52) U.S. Cl. CPC F16K 25/005; F16K 17/20; B25D 2250/181; B25D 2222/06; B25D 9/16

(57) ABSTRACT

A carbon-fiber seat for a pneumatic hammer has a rear valve, a front valve, and a valve plate. The rear valve, the front valve, and the valve plate are made of carbon fiber materials. The rear valve has an inlet recess, an inlet passage, an exhaust annular recess, at least one exhaust port, and at least one exhaust passage. The front valve abuts the rear valve and has a communicating recess, an exhaust mount, and at least one exhaust port. The communicating recess is formed through the front valve, and communicates with the inlet recess of the rear valve. The exhaust mount is formed on and protrudes axially from the front valve around the communicating recess. The at least one exhaust port is formed in the exhaust mount such that the communicating recess communicates with the outer recess. The valve plate is deposited between the two valves.

### BACKGROUND OF THE INVENTION

### 1. Field of the Invention

The present invention relates to a carbon-fiber seat for a pneumatic hammer, and more particularly to a carbon-fiber seat for a pneumatic hammer that may improve the sensitivity of the pneumatic hammer, may reduce cost of use, and may save energy consumed by the carbon-fiber seat.

### 2. Description of the Prior Arts

A conventional pneumatic hammer is driven to move in a straight line to impact an object by controlling the flow direction of high-pressure gas. The conventional pneumatic hammer has a casing and a seat deposited in the casing to control the flow direction of high-pressure gas. The seat of the conventional pneumatic hammer is made of plastic or metal. The weight of the plastic seat is lighter, but the structural strength of the plastic seat is insufficient. After prolonged use, the plastic seat of the conventional pneumatic hammer may be cracked or damaged, and this will influence the flow of high-pressure gas and power transmission. Then, the conventional pneumatic hammer with the plastic seat cannot process accurately, and this will increase the processing time. In addition, the user may need to purchase a new seat to replace the broken seat, and this will increase the cost of use.

Furthermore, the structural strength of the metal seat is sufficient to prevent cracking or damaging after a long time use, but the weight of the metal seat is heavy, and may need more higher pressure of gas to drive the metal seat of the conventional pneumatic hammer, and this not only increases energy consumption relatively but also has a problem of heavy load.

To overcome the shortcomings, the present invention provides a carbon-fiber seat for a pneumatic hammer to mitigate or obviate the aforementioned problems.

### SUMMARY OF THE INVENTION

The main objective of the present invention is to provide a carbon-fiber seat for a pneumatic hammer, and more particularly to a carbon-fiber seat for a pneumatic hammer that may improve the sensitivity of the pneumatic hammer, may reduce cost of use, and save energy consumed by the carbon-fiber seat.

The carbon-fiber seat for a pneumatic hammer in accordance with the present invention has a rear valve, a front valve, and a valve plate. The rear valve, the front valve, and the valve plate are made of carbon fiber materials. The rear valve has an inlet recess, an inlet passage, an exhaust annular recess, at least one exhaust port, and at least one exhaust passage. The front valve abuts the rear valve and has a communicating recess, an exhaust mount, and at least one exhaust port. The communicating recess is formed through the front valve, and communicates with the inlet recess of the rear valve. The exhaust mount is formed on and protrudes axially from the front valve around the communicating recess. The at least one exhaust port is axially formed in the exhaust mount such that the communicating recess communicates with the outer recess. The valve plate is deposited between the rear valve and the front valve.

Other objectives, advantages and novel features of the invention will become more apparent from the following detailed description when taken in conjunction with the accompanying drawings.

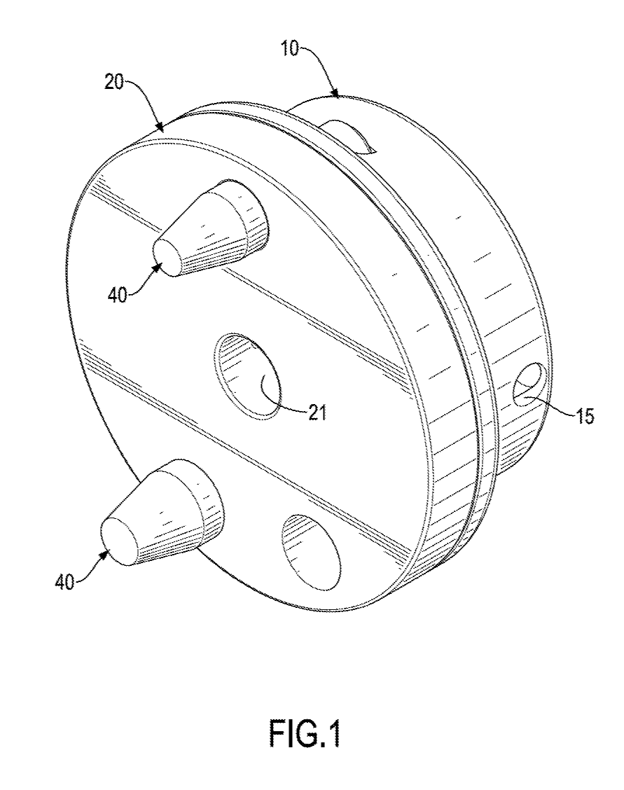

FIG. 1 is a perspective view of a carbon-fiber seat for a pneumatic hammer in accordance with the present invention;

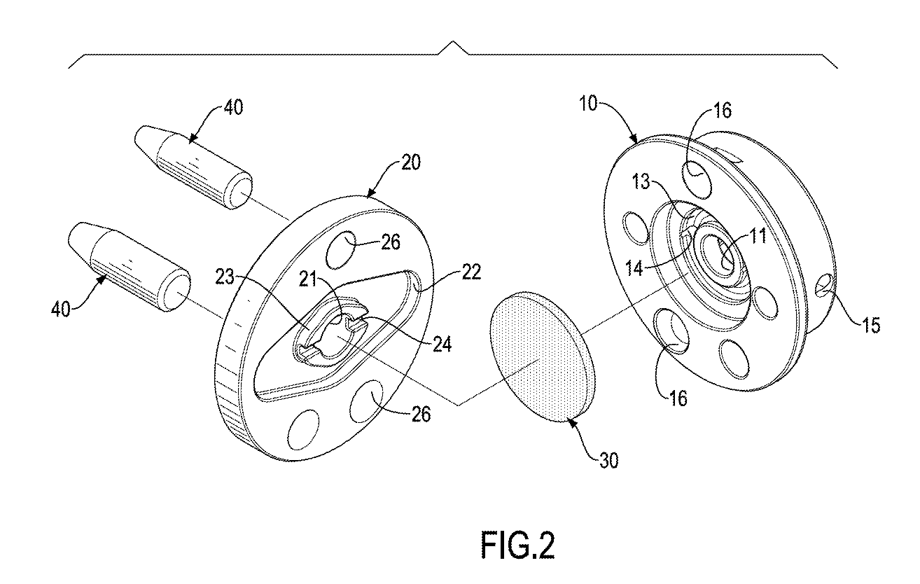

FIG. 2 is an exploded perspective view of the carbon-fiber seat for a pneumatic hammer in FIG. 1;

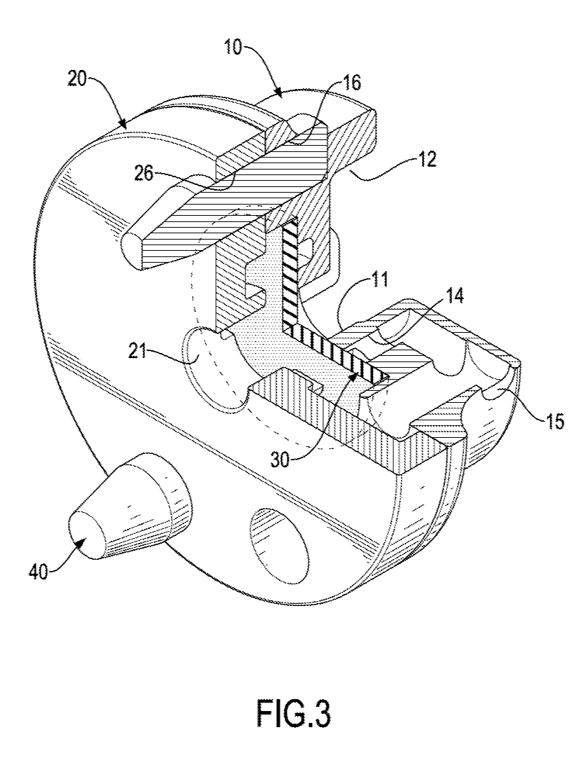

FIG. 3 is a partial perspective cross-sectional view of the carbon-fiber seat for a pneumatic hammer in FIG. 1;

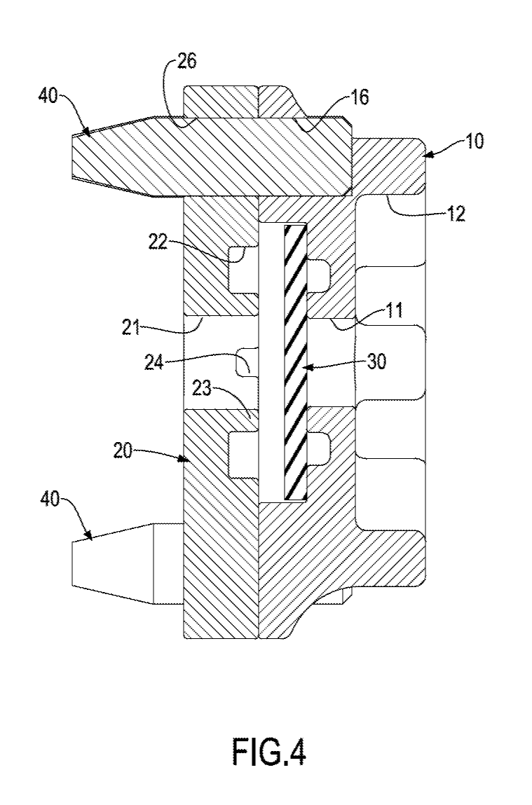

FIG. 4 is a cross sectional side view of the carbon-fiber seat for a pneumatic hammer in FIG. 1:

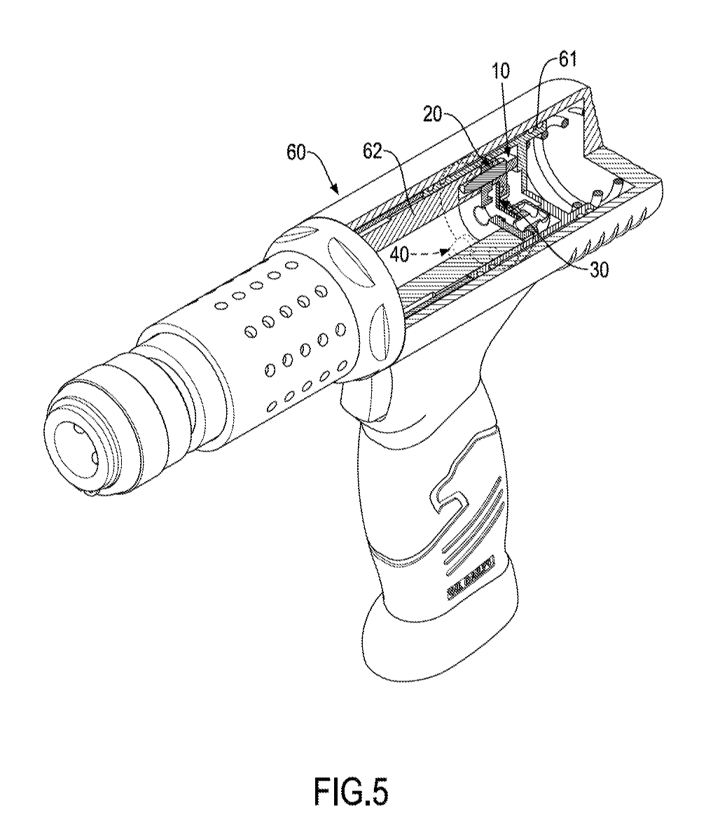

FIG. 5 is an operational and partial perspective cross-sectional view of the carbon-fiber seat in FIG. 1, deposited on a pneumatic hammer; and

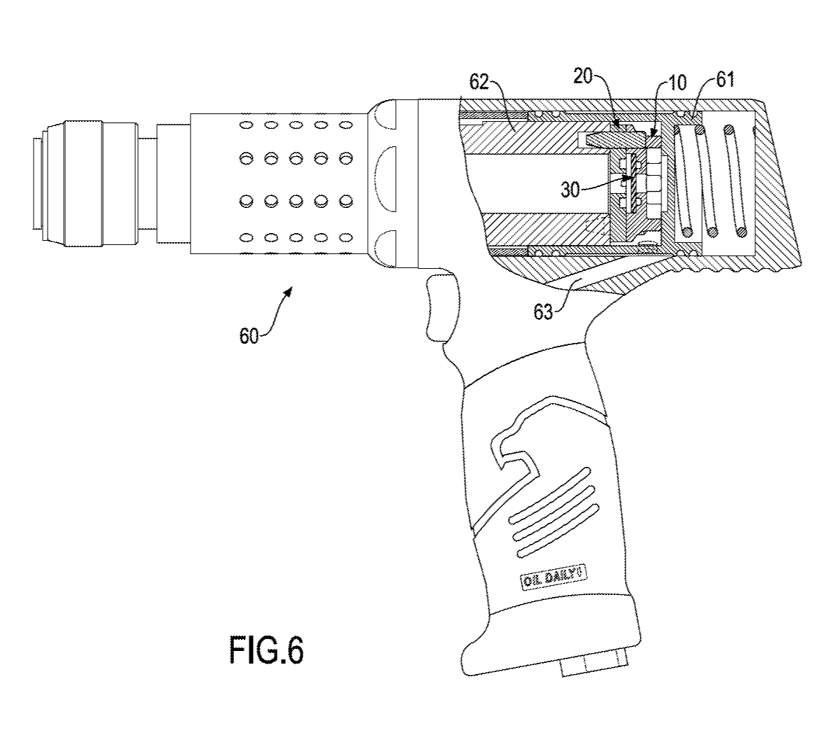

FIG. 6 is an operational and partial side view of the carbon-fiber seat for a pneumatic hammer in FIG. 5.

### DETAILED DESCRIPTION OF THE PREFERRED EMBODIMENTS

With reference to FIGS. 1 to 4, a carbon-fiber seat for a pneumatic hammer in accordance with the present invention comprises a rear valve 10, a front valve 20, a valve plate 30, and at least one fixing pin 40.

The rear valve 10 is an annular body, is made of carbon fiber materials, and has a rear side, a front side, an external surface, a center, an inlet recess 11, an inlet passage 12, an exhaust annular recess 13, at least one exhaust port 14, at least one exhaust passage 15, and at least one fixing hole 16. The inlet recess 11 is formed in the front side of the rear valve 10 at the center of the rear valve 10. The inlet passage 12 is axially formed through the rear side of the rear valve 10 at the center of the rear valve 10, and communicates with the inlet recess 11. The exhaust annular recess 13 is formed in the front side of the rear valve 10 around the inlet recess 11, and has a bottom. The at least one exhaust port 14 is axially formed in the bottom of the exhaust annular recess 13. The at least one exhaust passage 15 is radially formed through the external surface of the rear valve 10 and communicates with the at least one exhaust port 14. The at least one fixing hole 16 is formed in the front side of the rear valve 10 adjacent to the exhaust annular recess 13. Furthermore, the rear valve 10 has two fixing holes 16 formed in the front side of the rear valve 10 at a spaced interval and adjacent to the exhaust annular recess 13.

The front valve 20 is an annular body corresponding to the rear valve 10, is made of carbon fiber materials, and abuts the rear valve 10. The front valve 20 has a rear side, a front side, a center, a communicating recess 21, an outer recess 22, an exhaust mount 23, at least one exhaust port 24, and at least one through hole 26. The rear side of the front valve 20 abuts the front side of the rear valve 10. The communicating recess 21 is formed through the front side and the rear side of the front valve 20, and communicates with the inlet recess 11 of the rear valve 10. The outer recess 22 is formed in the rear side of the front valve 20 around the communicating recess 21, and has a bottom. The exhaust mount 23 is formed on and protrudes axially from the bottom of the outer recess 22 between the outer recess 22 and the communicating recess 21, and has a steeped flange deposited between the exhaust mount 23 and the outer recess 22. The at least one exhaust port 24 is axially formed in the steeped flange of the exhaust mount 23 such that the communicating recess 21 communicates with the outer recess 22. The at least one though hole 26 is formed through the front side and the rear side of the front valve 20, and aligns with the at least one fixing hole 16 of the rear valve 10. Additionally, the front valve 20 has two through holes 26 formed through the front side and the rear side of the front valve 20 at a spaced interval, and respectively aligning with the two fixing holes 16 of the rear valve 10.

The valve plate 30 is an annular disk, is made of carbon fiber materials, and is deposited between the rear valve 10 and the front valve 20. The valve plate 30 is mounted in the exhaust annular recess 13 of the rear valve 10 between the rear valve 10 and the front valve 20. The at least one fixing pin 40 is mounted through the at least one through hole 26 of the front valve 20, and is connected to the at least one fixing hole 16 of the rear valve 10 to connect the front valve 20 with the rear valve 10. In addition, the carbon-fiber seat has two fixing pins 40 passed through the two through holes 26 of the front valve 20 respectively, and connected to the two fixing holes 16 of the rear valve 10 respectively.

With reference to FIGS. 5 and 6, the carbon-fiber seat of the present invention in use is deposited in a casing of a pneumatic hammer 60 between a shock mount 61 and a cylinder 62 of the pneumatic hammer, and communicates with an inlet channel 63 of the pneumatic hammer 60 to enable high pressure gas to flow in the casing to drive the pneumatic hammer to work. Since the rear valve 10, the front valve 20, and the valve plate 30 are made of carbon fiber materials, the structural strength of the carbon-fiber seat is sufficient to prevent cracking or damaging after a long time use, and the high pressure gas may flow smoothly and accurately to drive the pneumatic hammer 60, and this may reduce the processing time of the pneumatic hammer 60. Furthermore, the user may not need to purchase a new seat to replace the carbon-fiber seat, and this will reduce the cost of use.

Additionally, the weight of the carbon-fiber seat is lighter than the weight of the metal seat of the conventional pneumatic hammer, and this enables the carbon-fiber seat to be driven without needing higher pressure of gas, and this saves energy relatively and solves the problem of heavy load.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A carbon-fiber seat for a pneumatic hammer comprising:
a rear valve made of carbon fiber materials, and having
a rear side;
a front side;
an external surface;
a center;
an inlet recess formed in the front side of the rear valve at the center of the rear valve;
an inlet passage axially formed through the rear side of the rear valve at the center of the rear valve, and communicating with the inlet recess;
an exhaust annular recess formed in the front side of the rear valve around the inlet recess, and having a bottom;
at least one exhaust port axially formed in the bottom of the exhaust annular recess; and
at least one exhaust passage radially formed through the external surface of the rear valve and communicating with the at least one exhaust port;
a front valve made of carbon fiber materials, abutting the rear valve, and having
a rear side abutting the front side of the rear valve;
a front side;
a center;
a communicating recess formed through the front side and the rear side of the front valve, and communicating with the inlet recess of the rear valve;
an exhaust mount formed on and protruding axially from the rear side of the front valve around the communicating recess; and
at least one exhaust port axially formed in the exhaust mount; and
a valve plate made of carbon fiber materials, and deposited between the rear valve and the front valve.

2. The carbon-fiber seat for a pneumatic hammer as claimed in claim 1, wherein
the front valve has an outer recess formed in the rear side of the front valve around the exhaust mount to hold the exhaust mount between the communicating recess and the outer recess, and communicating with the communicating recess; and
the valve plate is mounted in the exhaust annular recess between the rear valve and the front valve.

3. The carbon-fiber seat for a pneumatic hammer as claimed in claim 1, wherein
the rear valve has at least one fixing hole formed in the front side of the rear valve adjacent to the exhaust annular recess;
the front valve has at least one though hole formed through the front side and the rear side of the front valve, and aligning with the at least one fixing hole of the rear valve; and
the carbon-fiber seat has at least one fixing pin mounted through the at least one through hole of the front valve, and connected to the at least one fixing hole of the rear valve to connect the front valve with the rear valve.

4. The carbon-fiber seat for a pneumatic hammer as claimed in claim 2, wherein
the rear valve has at least one fixing hole formed in the front side of the rear valve adjacent to the exhaust annular recess;
the front valve has at least one though hole formed through the front side and the rear side of the front valve, and aligning with the at least one fixing hole of the rear valve; and
the carbon-fiber seat has at least one fixing pin mounted through the at least one through hole of the front valve, and connected to the at least one fixing hole of the rear valve to connect the front valve with the rear valve.

5. The carbon-fiber seat for a pneumatic hammer as claimed in claim 3, wherein
the rear valve has two fixing holes formed in the front side of the rear valve at a spaced interval and adjacent to the exhaust annular recess;
the front valve has two through holes formed through the front side and the rear side of the front valve at a spaced interval, and respectively aligning with the two fixing holes of the rear valve; and
the carbon-fiber seat has two fixing pins passed through the two through holes of the front valve respectively, and connected to the two fixing holes of the rear valve respectively.

6. The carbon-fiber seat for a pneumatic hammer as claimed in claim 4, wherein
the rear valve has two fixing holes formed in the front side of the rear valve at a spaced interval and adjacent to the exhaust annular recess;
the front valve has two through holes formed through the front side and the rear side of the front valve at a spaced interval, and respectively aligning with the two fixing holes of the rear valve; and
the carbon-fiber seat has two fixing pins passed through the two through holes of the front valve respectively, and connected to the two fixing holes of the rear valve respectively.
